(19) United States
(12) Patent Application Publication
(10) Pub. No.: US 2025/0116008 A1
(43) Pub. Date: Apr. 10, 2025

(54) METHOD OF ELECTROCHEMICALLY CONVERTING CARBON DIOXIDE INTO FORMATE SALTS

(71) Applicant: ÉLECTRO CARBONE INC., St-Bruno-de-Montarville (CA)

(72) Inventor: Ulrich LEGRAND, Longueuil (CA)

(21) Appl. No.: 18/729,409

(22) PCT Filed: Jan. 10, 2023
(86) PCT No.: PCT/CA2023/050017

§ 371 Date: Jul. 16, 2024

Related U.S. Application Data
(60) Provisional application No. 63/298,956, filed on Jan. 12, 2022.

(51) Int. Cl. C25B 3/07; C25B 3/26; C25B 9/77; C25B 15/029; C25B 15/08

(52) U.S. Cl. CPC C25B 3/07; C25B 3/26; C25B 9/77; C25B 15/029; C25B 15/083; C25B 15/085; C25B 15/087

(57) ABSTRACT

A method of producing formate salt from carbon dioxide; it includes receiving the carbon dioxide in a dry compartment, wherein the carbon dioxide diffuses from the dry compartment into a catholyte solution of a first wet compartment through the gas diffusion layer, and at least part of the carbon dioxide is transformed into formate by an electrochemical reaction, resulting in a formate-containing catholyte solution, whereby a carbonate byproduct is also produced from the carbon dioxide, remaining in the formate-containing catholyte solution; concentrating the formate in the formate-containing catholyte solution; separating the concentrated formate and the carbonate from the water of the formate-containing catholyte solution; and separating the carbonate from the formate to result in isolated formate salt.

The present disclosure claims priority from U.S. provisional patent application No. 63/298,956 filed on Jan. 12, 2022, incorporated herein by reference.

### TECHNICAL FIELD

The present disclosure relates to the field of electrochemistry, and more particularly to electrochemical cells for converting CO₂ into liquid chemicals.

### BACKGROUND

CO₂ accounts for over 80% of the global anthropogenic greenhouse gas (GHG) emissions that contribute to climate change [1]. Fossil fuel combustion is the largest contributor to the CO₂ released into the atmosphere. For instance, fossil fuel combustion represents over 75% of the total CO₂ emissions in the United States [2]. Transportation is the largest contributor to CO₂ emissions, with an estimated 15% share globally [3], with peaks over 30% for some countries, such as the United States [2]. Electric power, industrial and residential sectors follow [2].

A downstream CO₂ capture/conversion technology (CO₂ sink) would reduce the GHG concentration in the atmosphere. To sink the CO₂ coming from fossil fuel combustion, the first stage is CO₂ capture [4], [5] and then either its storage [4] or conversion to fuels and chemicals [6]-[8]. A more or less appropriate approach to decrease CO₂ emissions depends on the sector and follow technological trends. For instance, in the transportation sector, electrification [9] through plug-in hybrid electric vehicles (PHEVs) and plug-in electric vehicles (PEVs) equipped with efficient Li-ion batteries [10], [11] seems the most viable short-term option. In the electric power sector renewable energy feeding smart electricity grids in distributed energy generation (DEG) systems have the potential to replace traditional electricity power plants and decrease CO₂ emissions [12]. For the industrial sector, process intensification (PI) technologies promise to decrease energy requirements from 20% to 80% [13], with a corresponding reduction in GHG emissions [14].

Global sales of electric vehicles (EVs) boomed from less than 10,000 units in 2010 to 2.2 million in 2019 [15], [16]. Breakthroughs in electrochemical energy storage technologies contributed to its rapid development over the last decade [15]. EVs have a huge potential market. Tesla and Nissan are established EV global players [17], while BMW [18] and Volvo [19] have committed to invest in electric cars and fuel-cell research. EVs are an environmental-friendly alternative to fossil fuel powered vehicles (especially when the electricity comes from a renewable source). Although EVs powered by Li-ion batteries dominate the market, issues concerning their energy storage capacity, safety and cost encouraged a shift towards alternative technologies such as fuel cells (FC) [15]. A FC requires a continuous source of fuel (chemical energy) and oxygen (or air) to sustain the redox reactions. FC technology prevents environmental pollution and provides environmentally friendly energy [20]. Furthermore, it offers practical benefits over batteries with high energy density and requires only 5 to 10 minutes for a full recharge [21], [22]. FA is a candidate fuel for FC applications that may in turn be produced from CO₂, thus also contributing decreasing greenhouse gases in the atmosphere.

Along with carbon monoxide (CO), formic acid (FA) is a common product of CO₂ electroreduction. Metal catalysts that convert CO₂ to CO include Cu [23], Ag [24], Au [25], Pd [26] and many others. On the other hand, the CO₂ to FA transformation occurs in the presence of post-transition metal catalysts such as Sn, Pb, and Bi [27], [28] but it occurs on Cu as well [29].

The most obvious utilization of CO is syngas, which requires H₂, possibly provided by water electrolyzers powered by renewable sources. Syngas can then feed the Fischer-Tropsch process to produce liquid fuels for traditional vehicles [30], [31] or be converted to methanol [32], besides being a reagent for hydroformilation reactions [33].

Electrochemical reduction is particularly promising to convert carbon feedstock into valuable chemical fuel such as FA. While there are various methods of storage and conversion to fuels and chemicals from CO₂, FA from CO₂ as a green feedstock has a high economical potential and future applications in FC [6]-[8]. FA is a promising fuel which is readily processed and carried commercially [20]. However, despite the rise of electricity-driven technologies and the production of FA from green feedstock, the FA market is still limited, unless new technologies requiring it (e.g. FA fuel cells) reach commercial maturity. FA fuel cells (FAFC) represent a potential solution to expand the current market needs. FA is a small molecule that does not require storage at high pressures and it feeds directly the FC, without the need for a catalytic reforming unit [34]. Since FA represents a form of carbon-based energy from CO₂ and H₂, it is an ideal feedstock for FCs to produce electricity and reduce environmental impact. Specifically, direct FA fuel cells (DFAFC) are attractive for small portable FC applications and promising for automotive batteries by vehicle electrification [35]-[37]. DFAFC have the potential for a carbon neutral cycle where CO₂ is first captured and then transformed into FA through an electrolyzer. Afterwards, FA is used in the FC to generate electricity and power vehicles, reemitting the previously captured CO₂. The carbon neutrality of this cycle depends on the usage of renewable sources of electricity along the entire process.

In 2014, the worldwide production of formic acid (FA) was on the order of 800,000 tons per year [38]. The total trade value of FA in 2018 was $430 million [39]. The predominant markets for FA consumption are Asia and Europe (48% and 36% share, respectively) [40]. FA sold at a concentration of 85% is the global industry standard, but special applications require a concentration of 99% [40]. The historic use of FA for leather hide tanning has decreased over the past 20 years due to the shrinking leather industry. Pharmaceutical production, food industry, textiles, drilling fluids, and airport runway deicers, natural rubber, chemicals, and animal feed account for the remaining consumption [40].

Formic acid (FA) is typically produced by the reaction between methanol and CO in the presence of a strong base, followed by methyl formate hydrolysis [38], hydrolysis of formamide, and acidolysis of formate salts [44]. The production of FA from renewable sources, either from biomass [45] or from CO₂ brings environmental benefits while reducing dependence on fossil fuels [46].

In CO₂ electroreduction, cell conditions are neutral to alkaline in most cases and formate (HCOO—) is produced. Lowering the pH then generates FA. Several papers refer to FA, while they actually produce formate. The conversion of formate to FA is unrelated to electrochemical performance. Most literature data on the CO₂ electroreduction in H-cells (simplest devices for quick electrochemical tests, so called for the typical H-shape) report faradaic efficiencies of more than 80% for large current densities (Table 1).

TABLE 1
the electrochemical performance of exemplary
CO₂ catalysts known in the art.

| | | | FE | | |
|---|---|---|---|---|---|
| | | Potential | toward | Current | |
| | Elec- | (V vs | FA | density | |
| Catalyst | trolyte | RHE) | (%) | (mA/cm²) | Reference |
| Pb electrode | 50 g/L | −1.6 V | 100 | 115 | [47] |
| | NaSO₄ | | | | |
| Ru—Pd | 0.5M | −1.1 V | 90 | 80 | [48] |
| | KHCO₃ | | | | |
| S- modulated Sn | 0.1M | −0.75 | 93.3 | 55 | [49] |
| on Au needles | KHCO₃ | | | | |

In alkaline conditions, the half-electrochemical reactions at the cathode and the anode are:

CO₂+2H₂O+2e⁻=HCOOH+2 HO⁻(cathode)

2 HO⁻=H₂O+½O₂+2e⁻(anode)

and the overall electrochemical reaction is the following:

CO₂+H₂O=HCOOH+½O₂

Commercially viable systems to convert CO₂ to formate require current densities of at least 200 mA/cm² over time [50] and higher for more compact electrodes driving the overall electrolyzer cost down, whereas faradaic efficiency, which can reach 90%, are less of a limiting factor for commercial application. In the electroreduction of CO₂ to ethylene, Dinh et al. showed that increasing the electrolyte concentration up to 10M KOH decreased the ohmic overpotential by a factor of 47 [51]. H-cells are an appropriate set-up to screen and compare catalysts at laboratory scale. However, there are several issues preventing the scalability of the system, i.e. poor solubility of CO₂ in water and aqueous electrolytes, as well as limited diffusivity towards the electrode. Like water electrolyzers, industrial CO₂ electrolyzer systems should consist of stacked flow cells.

Some literature examples report lab-scale cell designs that allow a systematic scale up, i.e. membrane-based and microfluidic flow cells [50]. Both of these cells attain current densities beyond 200 mA/cm2 at the laboratory scale. Strategies to further improve the current density consist of (1) placing the cathode electrode at the interface between the electrode and the gaseous CO₂ [52] and (2) improving CO₂ solubility with non-aqueous electrolytes [53]. In the first case, pressure equilibration between the liquid electrolyte and the gaseous CO₂ needs to be ensured to prevent products crossflow through the porous electrode. The second case could see decreases of ionic conductivity and thus overall cell performance with the use of non-aqueous electrolyte. Between 2007 and 2017, more than 1,000 research articles report catalysts analyzed on H-cells; however, only 21 articles report on flow cells, limiting the data set for this technology in CO₂ reduction [50]. A conventional 3-compartment cell with a catalyst coated gas diffusion layer (GDL) positioned between the CO2 compartment and the catholyte compartment is used in the present process. The anode catalyst is placed in the third compartment with the anolyte flowing and separated from the catholyte by an ion-exchange membrane, as seen in Error!Reference source not found.

### SUMMARY

The present disclosure relates to a method of producing formate from carbon dioxide using a stack of electrochemical cells. The catholyte is recirculated in the cell stack until a desired concentration of formate is achieved. The formate is then separated from other biproducts (e.g. carbonate salt) and stored for future use.

A broad aspect is a method of producing formate salt from carbon dioxide using at least one electrochemical cell with a dry compartment for receiving carbon dioxide gas, a first wet compartment with a catholyte solution, where a gas diffusion layer separates the dry compartment and the first wet compartment, and a second wet compartment with an anolyte solution. The method includes receiving the carbon dioxide in the dry compartment, wherein the carbon dioxide diffuses from the dry compartment into the catholyte solution of the first wet compartment through the gas diffusion layer, and at least part of the carbon dioxide is transformed into formate by an electrochemical reaction, resulting in a formate-containing catholyte solution, whereby a carbonate by-product is also produced from the carbon dioxide, remaining in the formate-containing catholyte solution; concentrating the formate in the formate-containing catholyte solution; separating the concentrated formate and the carbonate from the water of the formate-containing catholyte solution; and separating the carbonate from the formate to result in isolated formate salt.

In some embodiments, the method may include storing the isolated formate salt.

In some embodiments, the carbon dioxide may be pressurized prior to the receiving.

In some embodiments, the at least one electrochemical cell may include a plurality of electrochemical cells forming a cell stack.

In some embodiments, the concentrating may be performed by reintroducing the formate-containing catholyte solution into the at least one electrochemical cell, thereby permitting additional carbon dioxide to react with the catholyte through an electrochemical reaction of the formate-containing catholyte solution to generate additional formate, increasing the concentration of the formate in the formate-containing catholyte solution.

In some embodiments, the method may include, after the concentrating, detecting a concentration of one or more solutes in the formate-containing catholyte solution, indicative of a concentration of formate in the formate-containing catholyte solution.

In some embodiments, a concentration of formate may be detected in the formate-containing catholyte solution.

In some embodiments, the catholyte solution and the anolyte solution may contain hydroxide salt.

In some embodiments, the anolyte solution leaving the at least one electrochemical cell may be degassed to remove oxygen resulting from an electrochemical reaction of the anolyte solution occurring in the second wet compartment, and may be passed through a heat exchanger to remove heat prior to reintroduction into the at least one electrochemical cell.

In some embodiments, a concentration of the anolyte solution may be verified and adjusted prior to the reintroduction.

In some embodiments, the separating the concentrated formate and the carbonate from the water may be performed using heat.

In some embodiments, the separating the carbonate from the formate to result in formate salts may be performed by adding a solvent that dissolves the formate but not the carbonate, and wherein the solvent may be then evaporated to result in the formate salts.

In some embodiments, the solvent may be ethanol.

In some embodiments, the isolated formate salt may be crystallized.

In some embodiments, unreacted carbon dioxide of the carbon dioxide may be recirculated in the at least one electrochemical cell.

Another broad aspect is formate salt obtained by performing the method as defined herein.

In some embodiments, the formate salt may be in crystal form.

In some embodiments, the formate salt may be a liquid solution.

Another broad aspect is a system for transforming carbon dioxide into formate. The system includes a catholyte storage subsystem comprising a catholyte storage vessel with a catholyte solution; an anolyte storage subsystem comprising an anolyte storage vessel with an anolyte solution; a carbon dioxide inlet connected to the electrolyser for supplying carbon dioxide to an electrolyser; the electrolyser comprising at least one electrochemical cell with a dry compartment for receiving carbon dioxide gas, a first wet compartment with the catholyte solution supplied from the catholyte storage subsystem, where a gas diffusion layer separates the dry compartment and the first wet compartment, and a second wet compartment with the anolyte solution supplied from the anolyte storage subsystem, and configured to receive the carbon dioxide in the dry compartment, wherein the carbon dioxide diffuses from the dry compartment into the catholyte solution of the first wet compartment through the gas diffusion layer, and at least part of the carbon dioxide is transformed into formate by an electrochemical reaction, resulting in a formate-containing catholyte solution, whereby a carbonate by-product is also produced from the carbon dioxide, remaining in the formate-containing catholyte solution; a controller configured to determine if a threshold concentration of the formate in the formate-containing catholyte solution is reached, wherein the formate-containing catholyte is recirculated in the at least one electrochemical cells if the threshold concentration is not reached; a formate separation subsystem configured to: remove at least part of the water from the formate-containing catholyte solution; and separate the formate from the carbonate.

In some embodiments, the system may include an anolyte pH adjustment subsystem configured to receive used anolyte solution leaving the electrolyser; and adjust a concentration of a recycled anolyte solution at least including the used anolyte solution to a target concentration.

In some embodiments, the setting of the concentration of an anolyte solution at least including the used anolyte solution to a target concentration may be performed by measuring an ionic conductivity of the recycled anolyte solution.

In some embodiments, the controller that is configured to determine if a threshold concentration of the formate is reached may determine if a period of time has lapsed, the period of time associated with a number of recirculations of the formate-containing solution.

In some embodiments, the controller that is configured to determine if a threshold concentration of the formate is reached may be in communication with a detector to detect an ion concentration in the formate-containing solution, the ion related to a concentration of formate in the formate-containing solution.

In some embodiments, the removing the at least part of the water from the formate-containing catholyte solution may be performed through evaporation of the water.

In some embodiments, the removing the at least part of the water from the formate-containing catholyte solution may include performing reverse-osmosis to increase the concentration of the formate and the carbonate in the formate-containing catholyte solution; evaporating water of the formate-containing catholyte solution to cause precipitation of the carbonate in the formate-containing catholyte solution, resulting in water vapor; and causing further evaporating of the water of the formate-containing catholyte solution using the water vapor.

In some embodiments, the system may include one or more emergency sources of carbon dioxide that are adapted to provide carbon dioxide to the electrolyser if the carbon dioxide inlet fails to provide carbon dioxide, to avoid a change in pressure that can damage the electrolyser.

In some embodiments, the separating the formate from the carbonate may include causing a precipitation of the carbonate by evaporating a solvent in which the formate and carbonate are dissolved; and filtering out the precipitated carbonate.

In some embodiments, the electrolyser may be further adapted to recirculate unreacted carbon dioxide in the at least one electrochemical cell.

In some embodiments, the system may include a storage vessel for storing the formate that has been separated from the carbonate.

In some embodiments, the at least one electrochemical cell may include a plurality of electrochemical cells forming a cell stack.

In some embodiments, the catholyte solution and the anolyte solution may contain hydroxide salt.

In some embodiments, the electrolyser may be further configured to degas the anolyte solution leaving the at least one electrochemical cell to remove oxygen resulting from an electrochemical reaction of the anolyte solution occurring in the second wet compartment, and to pass the anolyte solution through a heat exchanger to remove heat, prior to recirculation into the at least one electrochemical cells.

In some embodiments, the anolyte storage subsystem may include an intermediate anolyte tank connected to the anolyte storage vessel, wherein the anolyte solution of the second wet compartment is supplied from the intermediate anolyte tank.

### BRIEF DESCRIPTION OF THE DRAWINGS

The invention will be better understood by way of the following detailed description of embodiments of the invention with reference to the appended drawings, in which:

FIG. 1A is a drawing of an exploded view of an exemplary 3-compartment electrochemical cell for converting carbon dioxide into formate.

FIG. 1B is a schematic of the exemplary 3-compartment cell of FIG. 1A.

FIG. 2 is a bloc flow diagram (BFD) of an exemplary CO₂ electrolyzer.

FIG. 3 shows maps illustrating the pressure difference across the gas diffusion layer in several cells of a CO₂ electrolyzer stack. A positive pressure difference denotes that the pressure is higher on the CO₂ side compared to the catholyte side. The black spots correspond to the gas and catholyte inlet (bottom left) and outlet (top right).

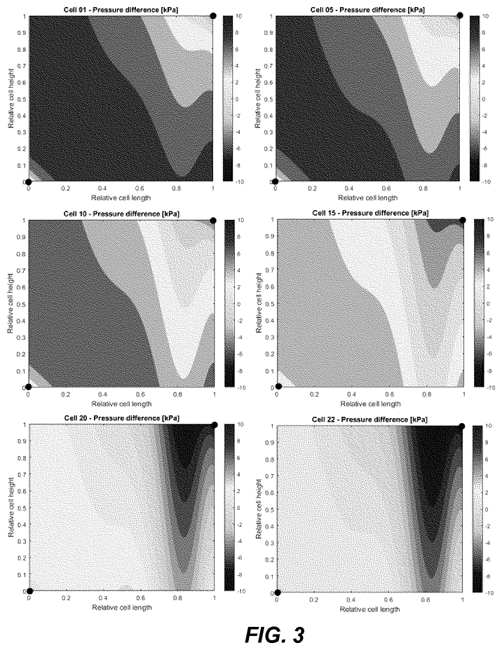

FIG. 4 shows graphs illustrating the temperature change in an exemplary phase change heat exchanger: waste heat boiler is shown in the left graph and a water condenser is shown in the right graph.

FIG. 5 is a process flow diagram associated with an exemplary CO₂ to potassium formate electrolyser.

FIG. 6 is a flowchart diagram of an exemplary method of producing formate from carbon dioxide.

FIG. 7 is a process flow diagram of an exemplary system for transforming carbon dioxide into formate.

FIG. 8 is a process flow diagram of an exemplary catholyte storage subsystem.

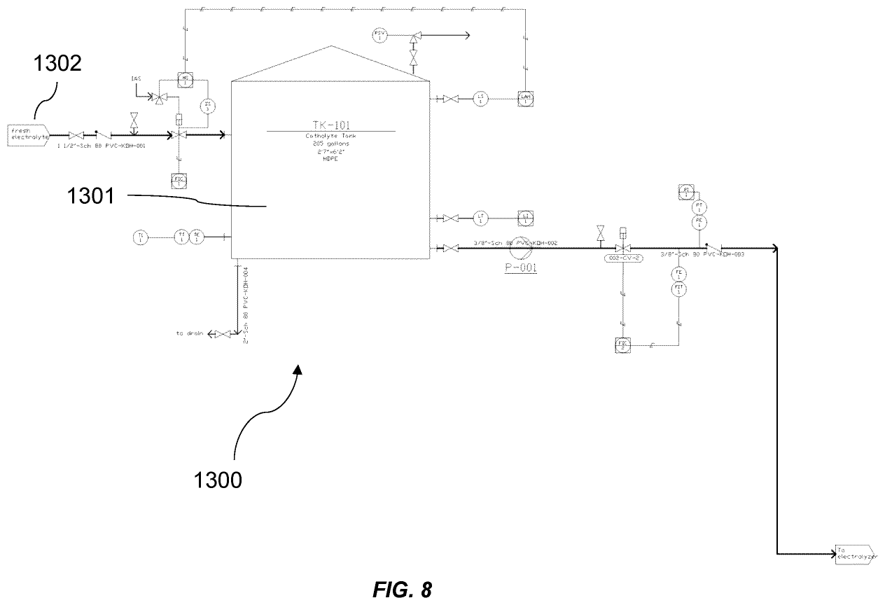

FIG. 9 is a process flow diagram of an exemplary anolyte storage subsystem.

FIG. 10 is a process flow diagram of an exemplary electrochemical cell stacksubsystem.

FIG. 11 is a process flow diagram of an exemplary anolyte pH adjustment subsystem.

### DETAILED DESCRIPTION

The present disclosure relates to a method of transforming carbon dioxide into formate, e.g., for use as a fuel, the method employing an electrolyser including an electrochemical cell stack.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

From the foregoing it will be appreciated that, although specific embodiments have been described herein for purposes of illustration, various modifications may be made without deviating from the spirit and scope of the teachings. Accordingly, the claims are not limited by the disclosed embodiments.

### Definitions

In the present disclosure, by “electrochemical cell” or “electrolyser cell”, it is meant a device that is capable of generating electrical energy either from chemical reaction(s) or using electrical energy to cause chemical reaction(s).

Faradaic efficiency refers to the percentage of electrons passing through the cathode that are participating in the CO₂ reduction towards a specific product, following the formula

$$FE = \frac{nzF}{it}$$

where n is the number of moles of generated product, z is the number of electron from the electrochemical reaction, F is the Faraday constant, and i is the measured current that passed through the electrode during the time t.
Exemplary Electrochemical Cell for Performing the Conversion of Carbon Dioxide into Formate Salts:

The methods of converting carbon dioxide into formate salts as described herein are performed using at least one electrochemical cell (in some embodiments, a cell stack of a plurality of electrochemical cells) in the system described herein. An exemplary electrochemical cell for performing the methods described herein include a dry compartment for receiving carbon dioxide, a wet catholyte compartment and a wet anodic compartment. A gas diffusion layer separates the dry compartment and the wet catholyte department. An ion exchange barrier (e.g. membrane) separates the catholyte compartment and the anolyte compartment, enabling passage of ions.

For purposes of illustration, reference will be made to the following electrochemical cell. However, it will be understood that the electrochemical cell described herein is but for illustration, and other electrochemical cells in accordance with the present teachings may be used.

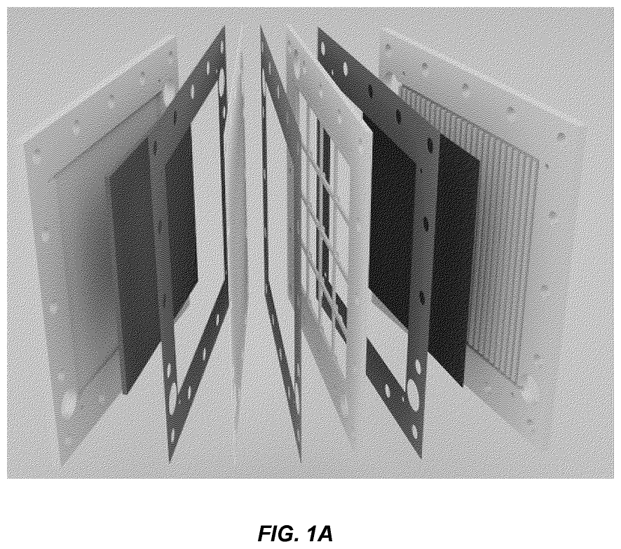

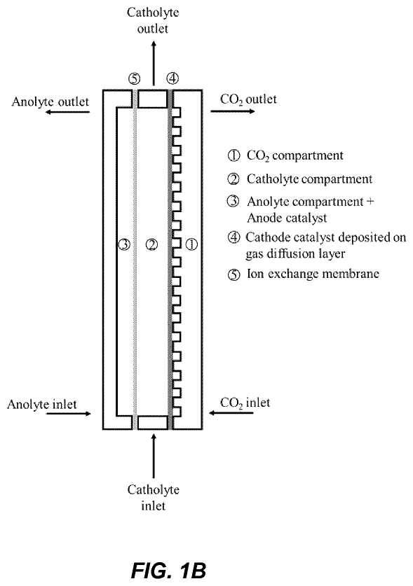

Reference is made to FIG. 1B illustrating an exemplary electrochemical cell for converting carbon dioxide in accordance with the present embodiments.

The electrochemical cell includes an anodic compartment, containing the anolyte solution, a dry compartment for receiving the carbon dioxide, and a wet compartment containing the catholyte solution. The dry compartment of the cathodic compartment and the wet compartment containing the catholyte solution may be separated by a gas diffusion layer, where the cathode may be joined to or integrated into the gas diffusion layer. The gas diffusion layer enables the carbon dioxide to diffuse from the dry compartment to the wet catholyte compartment through the gas diffusion layer. The cathodic compartment and the anodic compartment are separated with an anion exchange membrane, enabling transfer of anions from the cathodic compartment to the anodic compartment.

As explained herein, in some embodiments, the cathodic compartment may include a single wet compartment, where the carbon dioxide gas is injected directly into the electrolyte of the cathodic compartment. No dry compartment is present in this example.

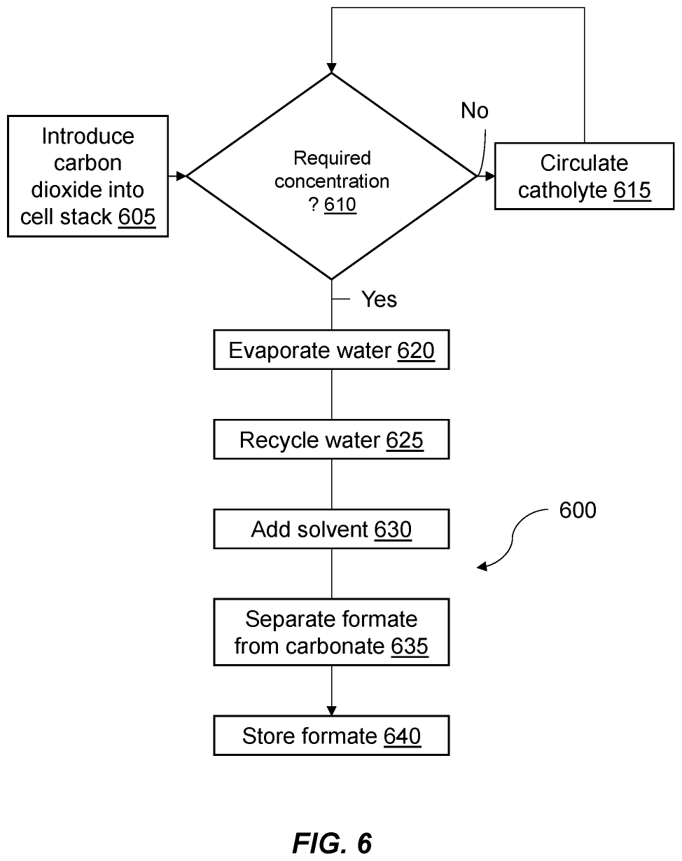

On the cathode side from FIG. 6, CO₂ is injected, e.g., in the dry compartment and diffused to a catalyst that is in contact with the electrolyte, a solution of potassium hydroxide, sodium hydroxide, potassium bicarbonate, sodium bicarbonate, a mixture of potassium and sodium bicarbonate, etc. For purposes of illustration, the present disclosure will refer to KOH as the electrolyte. However, it will be understood that other electrolyte solutions may be used in accordance with the present embodiments. The electrolyte may have a concentration ranging anywhere from 0.1 M to 10.0 M. In some examples, the electrolyte may have a concentration ranging anywhere from 5.0 to 10.0 M.

The injected CO₂ may be pure, or may have certain impurities (e.g. extracted from flue gas), with traces of nitrogen oxide, nitrogen dioxide, nitrogen, carbon monoxide, water, etc. (preferably no sulfur oxides or particle matters.) One molecule of CO₂ reacts with two molecules of water and two electrons to produce C1-C2 liquid organic by-products, namely a molecule of formic acid, and two hydroxide ions. It will be understood that the reaction may produce other by-products, such as ethanol, methanol, ethanoic acid, etc. The hydroxide ions diffuse through the anion exchange membrane from the cathode side to the anode side. In contact with the anode catalyst, two hydroxide ions produce a molecule of water, oxygen and two electrons. It can be noted that formic acid, in a highly basic environment is found under the form of formate ions (HCOO⁻). The two electrodes are surrounded by sealing gaskets and the assembly is connected electrically through a wired connection or is pressed between two current collector plates. The current collector plates have a flow pattern engraved on their surface for gas and liquid management. The sealing gaskets prevent any leaks from the cell. The current collector plates also deliver electricity to the electrolyzer cell.

The cathode electrode may be made of two components: a microporous support (e.g. made of carbon or metal), such as a gas diffusion layer (GDL), and a catalyst. The gas diffusion layer, as its name indicates, allows gaseous CO₂ to diffuse from the dry compartment to the catalyst, where the electrochemical reaction takes place. Gas diffusion layers may consist of pressed carbon fibers into a carbon paper. Commercial grades include Sigracet™, Freudenberg™ or Toray™ carbon papers. The gas diffusion layer may also include a microporous layer made of activated carbon as well as a hydrophobic treatment made of PTFE (polytetrafluoroethylene). The GDL is resistant to corrosion caused by the KOH electrolyte.

The cathode catalyst is directly responsible for the electrochemical reaction of CO₂ and water into liquid chemicals such as formic acid.

In some embodiments, the catalyst may be made from metal particles, preferentially at nanometric level to maximize surface area of contact with reactant. In other embodiments, the catalyst can also be used under the form of micrometric particles or even in bulk (e.g. the catalyst is structured of porous solid layers of metal, where no additional gas diffusion layer is required for depositing the catalyst thereon). The metal particles are part of the post-transition metals, a group of elements with high electronegativity and lower melting and boiling point than transition metals. Among the post-transition metals, tin, lead, indium, bismuth, tin oxide, lead oxide, indium oxide, bismuth oxide, metals doped with nitrogen and/or sulfur (e.g. tin doped with sulfur) have high reactivity and selectivity towards formic acid. Copper is recognized as a metal having a high reactivity towards numerous chemicals (methanol, ethanol, ethylene, propylene and many others) but with a lower selectivity.

The metal (e.g. metal particles) can be dispersed directly on the gas diffusion layer or on a carbon support that help to maintain performance stability and can even enhance it in certain cases. The support generally consists of crystallized forms of carbon or commercially available powders of active carbon for example. The metal may be deposited on the porous substrate by different depositing techniques, such as electroplating.

The anion exchange membrane is surrounded by the KOH electrolyte at the anode and at the cathode. The anion exchange membrane allows hydroxide ions to diffuse from the cathode to the anode. In the meantime, the membrane prevents other products to pass from one side to the other and is electrically insulative. The concentrations of the electrolyte on both sides are identical in order to limit osmotic pressure on the membrane. These membranes can be found commercially (Fumasep™, Sustainion™, etc.) or synthesized to optimize their properties regarding ion transport. Anion exchange membranes are composed of one or more ionomers, i.e. a polymer of both neutral and ionized monomers. The ionized monomers can include non-exhaustively quaternary ammonium, imidazolium, guanidinium, pyridinium, phosphonium, sulfonium, etc.

The anode catalyst completes the overall electrochemical reaction of CO₂ towards the liquid chemical by transforming hydroxide ions to oxygen gas and electrons that are transported to the cathode side. Nickel foam is a possible choice for the anode catalyst due to its high reactivity in a basic environment, its corrosion resistance in high pH and its large specific surface area. Other catalysts for the oxygen evolution reaction can include some transition metals (Fe, Ni, Co, Mg) in metallic, oxide, hydroxide or (oxy)hydroxide form as well as noble metals such as platinum or palladium. Noble metals are however not the preferred choice due to high cost. The metals can be included in the cell under the form of a foam, such as the nickel foam or on a gas diffusion layer, such as the one used on the cathode side. The foam form can increase contact between the electrolyte and the electrode, while also contributing to turbulence of the liquid. Other exemplary anodes may be in the form of a metal wire or a metal plate.

In one embodiment, in a stack of several cells, the anode and cathode plates can also be merged together into a bipolar plate where one face is engraved with the pattern for CO₂ flow while the other side is engraved with CO₂ flow patterns (or, in some examples, the KOH electrolyte pattern), where two neighboring cells can share the same anode electrode.

In some embodiments, a voltage of less than 10 V is present in the electrochemical cell. In some embodiments, a voltage of less than 4 V is present in the electrochemical cell.

In some embodiments, the current density that each electrode generates is higher than 100 mA/cm². In some embodiments, the current density that each electrode generates is higher than 200 mA/cm². When a higher current density is present, the system may be more compact, where less electrode surface area is required.

In some examples, CO₂ electrochemical cells are assembled into a cell stack and compressed between two end plates. The end plates ensure the structural integrity of the stack while providing inlets and outlets to the different manifolds. The end plates can be made of a corrosion-resistant metal with good mechanical properties (e.g. high tensile strength, low flexibility, etc., for reducing movement of the two endplates), such as stainless steel, for its mechanical properties. Anode and cathode plates in the middle of the stack can be merged into bipolar plates for higher compactness and lower leak risks.

In some embodiments, the cell stack includes a CO₂ inlet with CO₂ coming from either storage, or direct feed from industrial plant, or a CO₂ capture plant.

The cell stack may also include a CO₂ outlet, where the CO₂ can be recirculated in the cell stack. The cell stack may also include an electrolyte inlet in order to supply the electrolyte from a source (e.g. storage container) of the electrolyte solution.

In some embodiments, the cell stack includes an anolyte outlet, for evacuating from the cell stack anolyte that has been degassed from produced oxygen. The concentration and composition of the remaining electrolyte may be adjusted prior to being recirculated into the cell stack.

In some embodiments, the cell stack includes a catholyte outlet for evacuating from the cell stack one or more of components of a catholyte containing electrolyte solution, formate and dissolved carbonates. The catholyte may undergo separation by distillation and purification of the products. Remaining electrolyte will have its concentration adjusted before being recirculated into the cell stack.

Exemplary System for Transforming Carbon Dioxide into Formate:

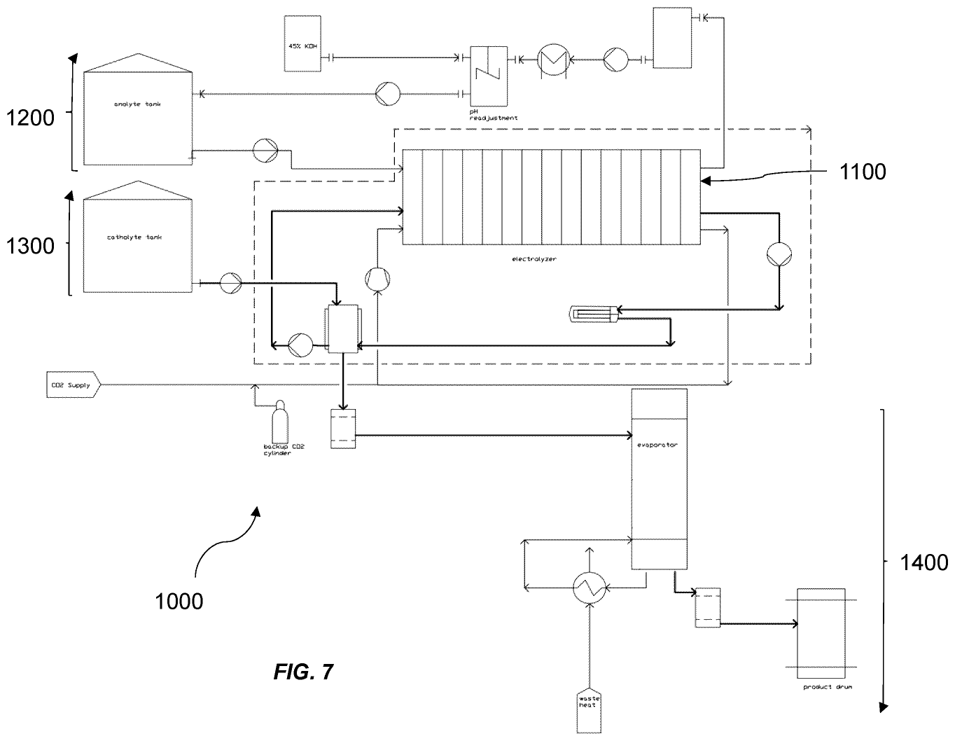

FIG. 7 illustrates an exemplary system 1000 for transforming carbon dioxide into formate. The system 1000 includes an anolyte storage subsystem 1200, a catholyte storage subsystem 1300 an electrolyser subsystem 1100 and a separation subsystem 1400.

Electrochemical flow cells of the electrochemical cell stack subsystem 1100 are operated with a continuous flow of electrolyte, but the process itself may not be performed in continuous operation, as the product generated within the residence time is minimal and cannot feasibly be separated. Hence the catholyte is recycled back to the electrolyser inlet and is caused to further react until the desired product concentration is attained. An option is to set up a recycle stream, but the required recycle ratio required would be so high that the process is effectively operated by batch. For batch operation, a minimum electrolyte volume required for stable operation of electrochemical cells may be established. As this exceeds the volume of the cells and the pipes, the batch volume may be increased with the use of an intermediate tank holding the bulk of catholyte, the catholyte delivered in batches. As the anolyte and the CO₂ streams are not concerned with product retention, they can be supplied continuously.

The electrochemical cell stack subsystem 1100 may include a controller (e.g. a computing device, a microprocessor; a processor and non-transitory memory including program instructions for causing the processor to perform a task) that is configured to determine if a threshold concentration of formate in the formate-containing catholyte has been reached. If the controller reaches a determination that the threshold concentration of formate in the formate-containing catholyte has been reached, the controller generates a command that causes a new volume of fresh catholyte solution to be introduced into the one or more electrochemical cells, the previous batch of formate catholyte solution no longer recirculated in the one or more electrochemical cells. However, if instead the controller reaches a determination that the threshold concentration of formate in the formate-containing catholyte has been reached, the controller may generate a command to cause the formate-containing catholyte solution to be recirculated in the one or more electrochemical cells. In some embodiments, the system may by default cause the recirculation of the current batch of formate-containing catholyte solution until the controller generates a command to introduce a new volume of catholyte solution into the one or more electrochemical cells.

In some embodiments, the controller may be in communication with a timer. The determination that the formate-containing catholyte solution has been reached may be based on the lapse of a period of time, the lapse of the period of time indicative of a number of cycles of the formate-containing catholyte solution in the one or more electrochemicals cells, the number of cycles of the formate-containing catholyte solution related to the concentration of formate in the formate-containing catholyte solution.

In some embodiments, the controller may be in communication with a detector to detect a concentration of a solute or ion in the formate-containing catholyte solution, the concentration of that solute or ion related to the concentration of formate in the formate-containing catholyte solution. The controller is configured to determine if the threshold concentration of formate in the formate-containing catholyte solution with readings received from the detector. In some examples, the solute is formate. However, it will be understood that concentrations of other solutes or ions, related to the concentration of formate, may also be detected without departing from the present teachings.

In some embodiments, the electrochemical cell stack subsystem 1100 includes one or more emergency sources of carbon dioxide 1102. The emergency sources of carbon dioxide 1102 are connected to the electrochemical cell stack 1101 to provide carbon dioxide to the electrochemical cell stack 1101 if ever the carbon dioxide inlet 1103 ceases to provide carbon dioxide to the electrochemical cell stack 1101. The provision of carbon dioxide by the emergency sources of carbon dioxide 1102 avoids a change of pressure related to the electrochemical cell stack 1101 that could damage the electrochemical cell stack 1101.

In some instances, the electrochemical cell stack subsystem 1100 is further configured to recirculate unreacted carbon dioxide into the electrochemical cell stack 1101.

In some instances, the electrochemical cell stack subsystem 1100 is further configured to degas the anolyte solution leaving the at least one electrochemical cell to remove oxygen resulting from an electrochemical reaction of the anolyte solution occurring in the second wet compartment, and optionally to pass the anolyte solution through a heat exchanger to remove heat. The heat that is removed from the heat exchanger may be extracted and redeployed in the system to, e.g., assist with the evaporation of water of the formate-containing catholyte solution to separate water from the carbonate-formate.

An exemplary electrochemical cell stack 1101 in accordance with the present teachings composed of a stack of 40 cells (it will be understood that the following properties may vary in accordance with the number of cells of the stack. The number of cells composing an electrochemical cell stack may also vary without departing from the present teachings) may have the following properties:
an electrical current passing in series through the cells between 300 A to 600 A, preferably between 350 A and 400 A;
a total voltage of the 40 cells between 120 V and 320 V, preferably between 120 V and 240 V;
a flow rate of carbon dioxide in the electrochemical cell stack between 400 and 2000 SCFH;
equal flow rates of catholyte and anolyte solution in the electrochemical cell stack between 20 and 120 GPM;
a difference of positive pressure between carbon dioxide and the output catholyte solution, exiting the electrochemical cell stack, between 0 and 5 PSI, and preferably between 1.5 and 3 PSI;
a pressure difference between the anolyte solution and the catholyte solution exiting the electrochemical cell stack between −2 PSI and 2 PSI, and preferably between −0.5 PSI and 0.5 PSI; and
temperature of the catholyte solution and of the anolyte solution maintained between 15° C. and 40° C., and preferably between 20° C. and 30° C.

Due to the batch operation of the reaction process, the subsequent product separation may also be operated in batches. When a batch from the electrochemical cell stack subsystem is released for separation, in one example, it is filled in a batch tank and heated with steam, until adequate evaporation is achieved; then, in that example, it is pumped to the filter press which is also a batch equipment operating in cycles.

Reference is now made to FIG. 7, illustrating an exemplary catholyte storage subsystem 1300 of the system 1000 for transforming carbon dioxide into formate. The catholyte and anolyte are stored separately.

The catholyte storage subsystem 1300 includes a storage tank 1301 for receiving and storing the catholyte from an electrolyte source 1302 (may be a manual, automated source). In one example, the catholyte tank receives 2M potassium hydroxide solution and is instrumented to retain the appropriate volume. When demanded, the stored catholyte is pumped further downstream. The storage tank 1301 may be open to atmosphere and may be equipped with emergency drains that can empty the tank 1301. The tank 1301 may be instrumented to have monitored temperature and level, the latter of which may be used to control filling and draining.

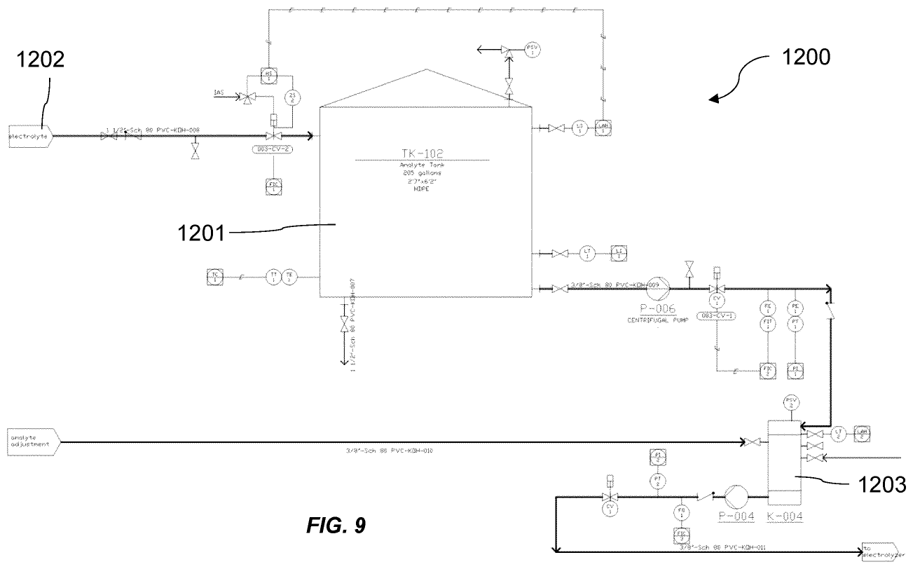

Reference is now made to FIG. 9, illustrating an exemplary anolyte storage subsystem 1200 of the system 1000 for transforming carbon dioxide into formate. The anolyte storage subsystem 1200 includes a principal tank 1201 for storing the anolyte, receiving anolyte from an anolyte source 1202 (may be a manual, automated source).

In some embodiments, the anolyte storage subsystem 1200 differs from the catholyte storage subsystem 1300 with the introduction of an intermediate tank 1203 for proper mixing after the adjustment phase by the anolyte pH adjustment subsystem 1500. In the process flow, the anolyte stream is not in contact with the catholyte.

However, within the electrochemical cell stack, ions migrate across the ionic exchange membrane, hence the composition of anolyte shifts if not constantly adjusted.

Like with the catholyte storage subsystem 1300, the anolyte storage subsystem 1200 is held under atmospheric pressure and room temperature, and its level is measured for inlet and outlet control. The storage tank 1201 may share a chemical drain with the catholyte tank 1301 in case of emergencies.

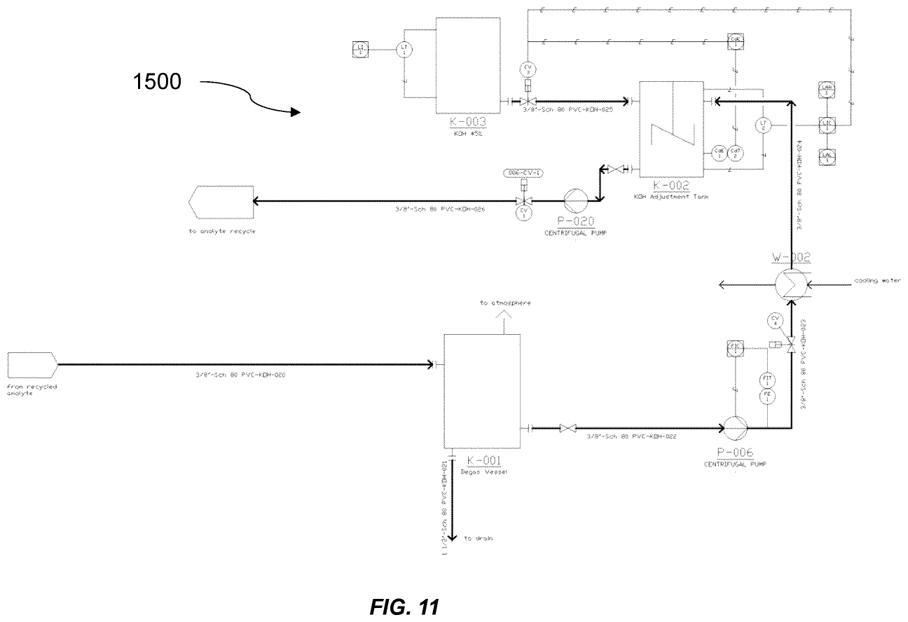

The anolyte storage subsystem 1200 may be connected to an anolyte pH adjustment subsystem 1500, as illustrated in the example of FIG. 11. The anolyte is constantly losing hydroxide ions to the catholyte, hence its pH is decreasing over time. When the anolyte is potassium hydroxide, since potassium hydroxide should be the only salt present in the anolyte stream, in order to maintain the initial hydroxide concentration, the anolyte stream is adjusted by adding concentrated potassium hydroxide to the system. In addition, the anode produces gaseous oxygen, the bulk of which is mixed and pumped along the pipes with the liquid. To prevent oxygen from building up or recycled through the system, a simple intermediate tank that is open to atmosphere is used as a degasser.

The anolyte pH adjustment subsystem 1500 may include a controller (e.g. a computing device, a microprocessor; including a processor and non-transitory memory including program instructions that are executable by the processor) that is configured to measure a concentration of the recycled anolyte solution. In some embodiments, the controller may be in communication with a sensor to detect the conduction of the recycled anolyte solution, the conduction related to the concentration of the anolyte in the recycled anolyte solution. In some embodiments, the controller may be in communication with a detector to detect a concentration of a solute or ion in the anolyte solution, related to the concentration of the anolyte in the anolyte solution. In some instances, the detector detects a concentration of anolyte in the anolyte solution.

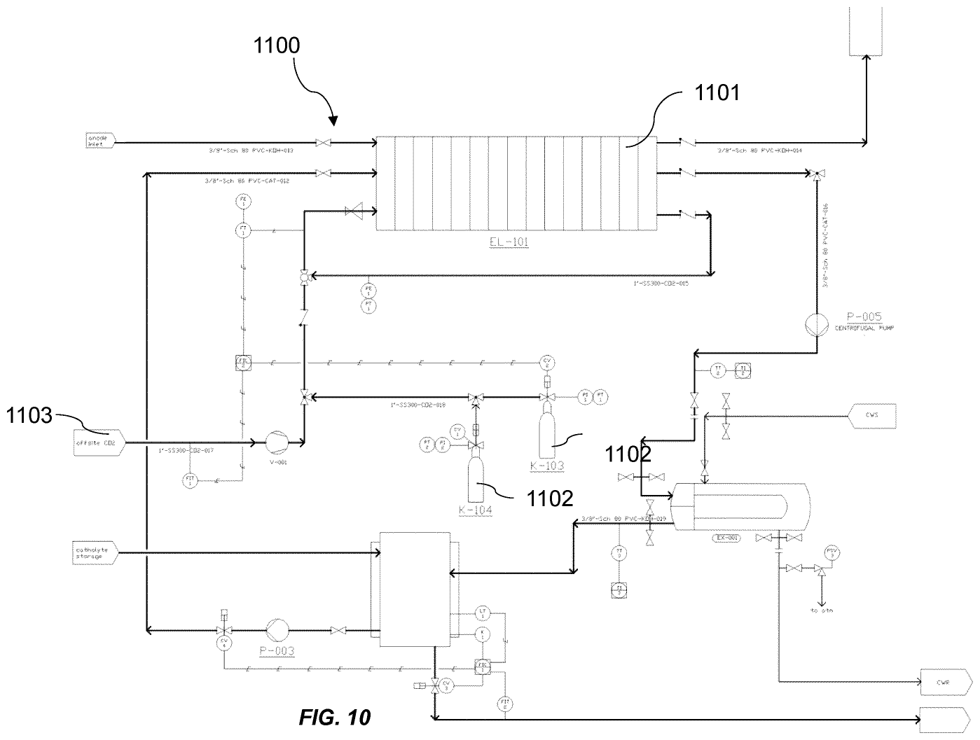

Another exemplary electrochemical cell stack 1101, of an electrochemical cell stack subsystem 1100 of the system 1000 for transforming carbon dioxide into formate is illustrated at FIG. 10. The catholyte section operates in batches, with a process tank that is filled from catholyte storage at the beginning of each cycle. The catholyte is pumped from this tank and is circulated in the cell stack cathode chambers until the end of the batch, at which point it is drained to this tank and pumped to the separations stage. Within the cycle, a chiller (or heat exchanger) may be present to prevent the catholyte from overheating due to the reaction's overpotential.

Carbon dioxide is continuously supplied to the electrolyser where a small portion will be consumed, and the balance is recycled to the electrolyser inlet. An alternative CO₂ supply is available in the form of compressed gas cylinders that act as backup CO₂ gas in terms of supply interruptions. Its purpose is to maintain CO₂ chamber pressure until the system can be shutdown and purged.

The anolyte is pumped to the cell stack inlet from the anolyte storage, and from the outlet flows to the pH readjustment process. Unlike the catholyte, the flow is continuous, and its composition should remain constant over time.

In some embodiments, water may be removed from the formate-containing catholyte solution, resulting in a concentrated formate and carbonate solution through evaporation of the water.

In some embodiments, water may be removed from the formate-containing catholyte solution, resulting in a concentrated formate and carbonate solution by performing reverse-osmosis to increase the concentration of the formate and the carbonate in the formate-containing catholyte solution, evaporating water of the formate-containing catholyte solution to cause precipitation of the formate and the carbonate in the formate-containing catholyte solution, resulting in water vapor, and causing further evaporating of the water of the formate-containing catholyte solution using the water vapor. The heat of the water vapor causes more solvent to evaporate.

Exemplary Method of Transforming Carbon Dioxide into Formate:

The method for converting carbon dioxide into formate is performed using an exemplary electrolyser as described herein.

Exemplary performance of the electrolyser is set at a faradaic efficiency (FE) of 90% towards formate, with a current density of −200 mA/cm² at a potential of −2.5 V vs Ag/AgCl, corresponding to a cell voltage of 4.0 V. In some embodiments, 1.25 mg/cm² of catalyst deposited on a commercial gas diffusion layer may be sufficient to reach this electrochemical performance.

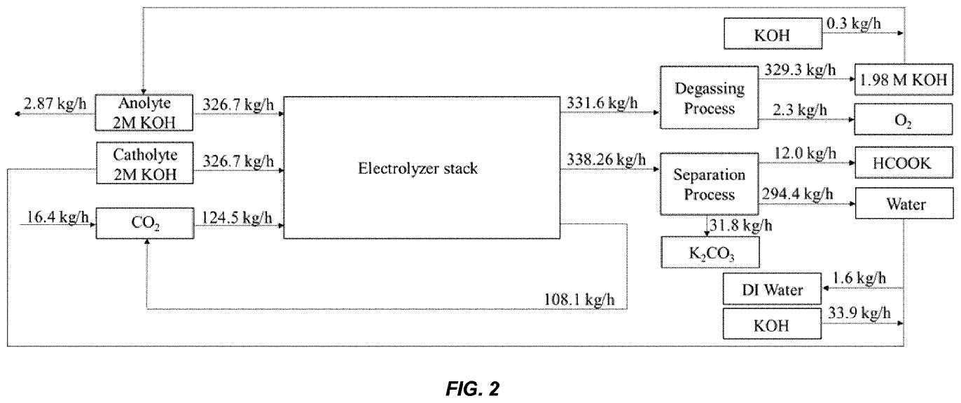

Reference is now made to FIG. 2, illustrating an exemplary set of chemical steps for transforming carbon dioxide into formate.

CO₂ is injected in the stack of cells where it diffuses through a gas diffusion layer and reacts on, e.g., the catalyst of the system of FIG. 1B, to generate potassium formate. Some CO₂ is also chemically dissolved into the KOH electrolyte and reacts to form potassium carbonate K₂CO₃. Only a minor fraction of CO₂ entering the stack is able to diffuse and react, while the majority of the injected gas exits the electrolyzer and can be recirculated. Prior to its injection in the electrolyzer, CO₂ can be compressed at relatively low pressure (˜3-6 bar) and stored in a tank. Co₂ compression can be done for two reasons. The first reason may be to overcome the pressure drop that it will undergo in the parallel cells. The second reason may be to generate of a CO₂ reserve in case the external CO₂ feed is discontinued for external reasons.

Catholyte and anolyte are injected in the cell stack as well and are composed of aqueous solutions of potassium hydroxide KOH at a concentration of 2M. The concentration of the formate in the catholyte may be increased by recirculating the catholyte several times in the electrolyser in order to build up the concentration of formate in solution. This concentration build-up results in an energy efficient separation process.

Separation may be performed via water evaporation to crystallize potassium formate and potassium carbonate. The separation of formate from carbonate can be achieved through solvent extraction since HCOOK is soluble in alcohol while K₂CO₃ is not. It will be understood that other solvents, aside from ethanol, may be used, provided the solvent can leverage the solubility of potassium formate and potassium carbonate in the selected solvent. After filtration, the alcohol can then be evaporated to obtain pure HCOOK. As such, the electrolyte is not recirculated, and some CO₂ is trapped under the form of potassium carbonate. In some embodiments, KOH could potentially be regenerated through a subsequent electrolysis of K₂CO₃.

On the anolyte side, oxygen is generated as a product. The oxygen is separated from the anolyte through degassing. The anolyte concentration is then adjusted before being recirculating in the electrolyser.

The CO₂ and electrolytes mass flow rates are accommodated in the cell stack in a geometry that minimizes the pressure difference across the gas diffusion layers present in the cells. The gas diffusion layers are porous to let the gas diffuse and react on the catalyst. The gas diffusion layers are placed at the interface between the gaseous CO₂ and the liquid catholyte. The pressure difference on this layer could result in product crossflow in the form of gas bubble formed in the catholyte or catholyte flowing in the CO₂ circulation line. Both effects are undesirable and the prevention of such crossflow is discussed in literature [55]. The same methods have been applied to determine an optimal cell and stack geometry and the resulting pressure difference across the gas diffusion layer is presented in Error!Reference source not found. The chemical dissolution of CO₂ to carbonate has also been taken into account in the pressure difference calculation, under the assumption that the residence time of the solution in the catholyte compartment provided sufficient time to fully convert KOH to K₂CO₃.

It has been determined that there should be preferentially a stack of 22 cells having a respective active surface area of 1,900 cm². The geometric size of the cells is influenced by the maximum size of the commercially available carbon cloth rolls to act as carbon support at the cathode. The pieces include distribution plates for the CO₂, catholyte and anolyte compartments, gaskets to ensure cell impermeability and a physical spacer in the catholyte to keep a constant distance between the GDL containing the catalyst layer and the AEM. The pieces for the CO₂, catholyte and anolyte compartments, and physical spacer will be made of polyethylene through machining. This material is chosen for its insulation properties as well as a great corrosion resistance towards concentrated KOH. The gaskets will be made of silicone rubber. Electric conduction is required at the anode catalyst, the nickel foam, and at the cathode. The nickel foam has a high electrical conductivity, so a simple wire or metal plate can be used to connect the anode to the electrical circuit. On the cathode side, the GDL is not as conductive and requires a homogeneous current distribution. It is proposed to cover the areas of the CO₂ distribution plate that are in direct contact with the GDL with adhesive copper film. This copper film can be connected to the exterior of the cell with a thin metal frame.

In some embodiments, the catholyte is recirculated in the electrochemical stack at least five times in order to concentrate potassium formate in the liquid and facilitate the post-processing separation of the products. After five iterations of recirculation in the stack, the amount of HCOOK in the catholyte may reach 15.3 wt %, assuming that 12.0 kg/h HCOOK are produced in each loop. K₂CO₃ is also present at concentrations of 8.1 wt %.

Further separation options to separate HCOOK from water and KOH will be discussed.

A first option is to lower the pH by the addition of hydrochloric acid HCl until there is mostly HCOOH in water (pKa HCOOH/HCOO⁻=3.77), as well as KCl. At low pH, K₂CO₃ is decomposed into H₂O, CO₂ and KCl. At this time, the solution can be degassed and distillated to extract pure formic acid. However, this strategy includes several downsides: the impossibility of recirculating KOH that has to be considered as a consumable and the complexity of distilling formic acid from water. Indeed, formic acid forms an azeotrope at 77.5 wt % and a higher pressure is required to shift the azeotrope point to higher concentrations. Stream stripping is also considered when extracting organic molecules from water, but cannot be applied in the case of formic acid in water, due to high solubility of formic acid in water as well as a boiling point slightly higher than water (100.7° C.). Finally, formate salt may be used for deicing applications and directly separating the salt appears more favorable.

A second option involves directly separating HCOOK from water and K₂CO₃ based on the solubility data of these salts in water, as summarized in Table 2:

TABLE 2
the solubility in water for HCOOK and K₂CO₃ salts.

| Solubility in water (g/100 mL) at | 25° C. | 0° C. |
|---|---|---|
| HCOOK | 331 | 33 |
| K₂CO₃ | 111 | 105.5 |

Solubility data of HCOOK and K₂CO₃ show that it is possible to selectively crystallize HCOOK at lower temperature while K₂CO₃ is still dissolved. For that, the concentration of the salts is to be increased by removing water and then the temperature of the concentrated solution is reduced for crystallization. Removing water can be done by evaporation of 90% of the water content in the solution exiting the stacks. An alternative method would be reverse osmosis (RO), but the pressure to remove as much water is greater than most reverse osmosis systems currently available. Ultra-high pressure reverse osmosis systems are rated at ˜120 bar while the osmotic pressure to concentrate the solution is higher than 1,000 bar. The evaporation of the solution may be done through a heat exchanger connected to waste heat available on industrial site. After 5 loops of catholyte circulation, the solution stream of 392.67 kg/h supposedly contains 15.3 wt % of HCOOK and 8.1 wt % of K₂CO₃, the rest being water, and equivalent to 300.7 kg/h. The stack outlet has thus concentrations of 20.0 g/100 mL of HCOOK and 10.6 g/100 mL of K₂CO₃. Evaporating 90% of the water through a waste heat boiler leaves HCOOK and K₂CO₃ concentrations at 200.0 and 105.8 g/100 mL respectively. Cooling down the HCOOK/K₂CO₃ slurry to 0° C. allows for selective crystallization of HCOOK while K₂CO₃ remains in solution. The HCOOK crystals can thus be filtered out by successive centrifugation. It can be noted that non-negligible amount of HCOOK remains in solution that is not recirculated and thus would go to waste.

Other exemplary methods for separation that may be included may be use of rising/falling-film evaporators. A rising/falling-film evaporator is a vertical tubular evaporator design where dilute feed enters at the bottom of the rising section and is pumped up, gaining velocity as boiling causes a mixture of liquid and vapor to discharge to the distributor of the falling section. After the downflow, an external separator separates the vapor and liquid phases.

Other exemplary methods for separation that may be included may be use of plate evaporators. Plate evaporators are constructed with plates gasketed so that they are connected either in series or in parallel, and they allow a small flow channel between them. The plates are clamped together in frames and can be operated as either rising or falling film evaporators.

Other exemplary methods for separation that may be included may be use of reverse osmosis. Reverse osmosis is a commonly used water purification technique that utilizes partially permeable membrane that is selective to water molecules but not larger ions.

Other exemplary methods for separation that may be included may be acidification. When acidified, potassium carbonate is reacted to a salt (depending on the acid) and carbon dioxide and water, while potassium formate is converted into formic acid. This eliminates the tertiary system and the only separation needed would be between a solute and its solvent.

Other exemplary methods for separation that may be included may be electrodialysis. Electrodialysis is an electrochemical method for the transport of ions. The dilute and concentrate streams are pumped through their respective compartments in an electrodialysis cell, separated by ion-exchange membranes. Under an applied potential bias, anions in the dilute stream are attracted to the anode and pass through the anion exchange membrane, but prevented from reaching the cathode by the cation exchange membrane. Similarly, cations migrate towards the cathode but cannot move past anion exchange membranes. With multiple cells with alternating membrane patterns, the concentrated stream at the end will contain the ions depleted from the dilute stream. Electrodialysis can be quite energy efficient, with common ion exchange membranes having current efficiencies between 90˜98% (note that this is not the energy efficiency).

In one embodiment, separation through evaporation of the water from the carbonate-formate in the formate-containing catholyte solution may be performed using a multiple-effect evaporator. In other embodiments, separation through evaporation of the water from the carbonate-formate in the formate-containing catholyte solution may be performed using single-stage evaporation, flash evaporation, thin-film evaporation, etc.

In an exemplary embodiment, separation first of the water from the carbonate-formate of the formate-containing catholyte solution, and then separation of the carbonate from the formate may be performed as follows:
perform reverse osmosis of the formate-containing catholyte solution to reach near-saturation point of formate-carbonate;
use a Multiple-effect evaporator to remove additional water;
use a crystallyzer to precipitate the carbonate salt;
employ a filter press to separate the solid carbonate from the solution containing formate; and
dry the solid carbonate.

To minimize the waste of valuable product, alcohol can be used as solvent extraction method in a HCOOK/K₂CO₃ slurry. HCOOK is soluble in alcohol while K₂CO₃ is insoluble.

In the CO₂ electrolyser process, heat exchangers are required at different stages to adjust the temperature of the following flows: catholyte and anolyte after passing through the electrolyser stacks to cool down to ambient temperature; catholyte in waste heat boiler for formate separation process; steam in condenser for water recovery; HCOOK/K₂CO₃ slurry to cool down for crystallisation and formate separation. The heat exchangers may be designed based on methods and procedure found in literature [57].

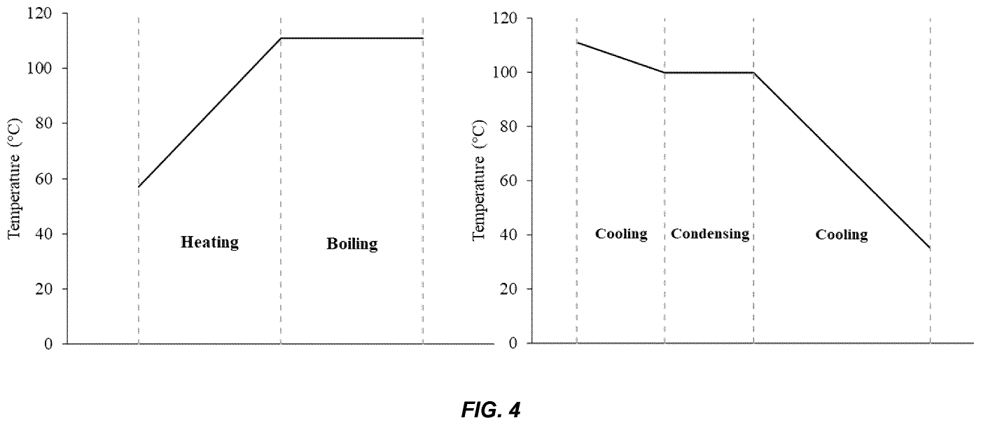

Notably, heat exchangers with a phase change occurring in it, i.e. waste heat boiler and water condenser, are respectively modelled as 2 and 3 successive heat exchangers to take into account temperature change and phase change, as illustrated on FIG. 4.

The stack of 22 electrochemical cells requires specific voltage and current, dictated by the inner cell properties. For the voltage, the 22 cells may require 4 V each, resulting in a 88 V requirement. The current density is fixed at 200 mA/cm² for a cell having a surface area of 1,900 cm², representing an overall current of 380 A. A DC to DC converter can provide the appropriate voltage and current, with an average of 92% efficiency. On top of the stacks and DC to DC converter, the additional electrical equipment is taken into account in the overall electrical consumption in Error!Reference source not found.

TABLE 3
exemplary electrical consumption of components used for carbon
dioxide transformation into formate with a cell voltage of 4 V.

| Unit | Electrical Power (kW) |
|---|---|
| Electroyzer stacks | 35 |
| DC/DC converter | 3.0 |
| Fans | 0.2 |
| Compressor | 1.6 |
| Pumps | 0.3 |
| Chiller | 0.3 |
| Total | 40.3 |

Different scenarios have been previously considered, with cell voltage varied from 4 to 8 V, that would affect the electrical considerations of the stack. The influence of the cell voltage on the stack electrical consumption is detailed in Table 4.

TABLE 4
exemplary levels of power requirement depending
on a given electrochemical cell voltage.

| | Stack power | |
|---|---|---|
| Cell Voltage (V) | requirement (kW) | Power density (mW/cm²) |
| 4 | 33.7 | 800 |
| 6 | 50.6 | 1200 |
| 8 | 67.4 | 1600 |

Electric equipment also includes Electronic Control Unit (ECU), system controller, bus bar, fuses, connector power, contactors, as well as current and voltage sensors.

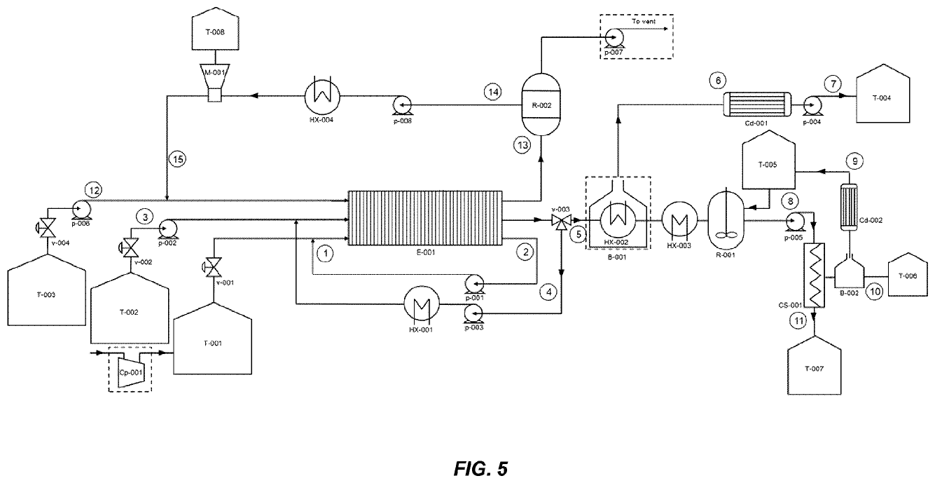

Reference is now made to FIG. 5 illustrating an exemplary process of transforming carbon dioxide into formate, with description of the major components in Error!Reference source not found. and description of the flows in Error!Reference source not found. Overall, the CO₂ electrolysis process may be divided into three major steps: CO₂ circulation, catholyte circulation and separation, and anolyte circulation and separation.

TABLE 5
identification of the components found in FIG. 5.

| Unit | Description | Material |
|---|---|---|
| T-001 | CO2 storage tank | Stainless steel |
| T-002 | KOH solution storage tank | Polyethylene |
| T-003 | KOH solution storage tank | Polyethylene |
| T-004 | Condensed water storage tank | Polyethylene |
| T-005 | Alcohol storage tank | Polyethylene |
| T-006 | HCOOK storage tank | Polyethylene |
| T-007 | K2CO3 storage tank | Polyethylene |
| T-008 | KOH pellets storage tank | Polyethylene |
| E-001 | Electrochemical cells stack | Polyethylene |
| Cp-001 | CO2 compressor | Stainless steel |
| HX-001 | Catholyte heat exchanger | Stainless steel |
| HX-002 | Heat exchanger for solution concentration | Stainless steel |
| HX-003 | Heat exchanger for slurry cooling | Stainless steel |
| HX-004 | Anolyte heat exchanger | Stainless steel |
| B-001 | Waste heat boiler | Stainless steel |
| B-002 | Electric boiler | Stainless steel |
| Cd-001 | Water condenser | Stainless steel |
| Cd-002 | Alcohol condenser | Stainless steel |
| CS-001 | Liquid-solid separator | Stainless steel |
| R-001 | Alcohol-slurry mixing reactor | Stainless steel |
| R-002 | Degassing reactor | Stainless steel |
| M-001 | Powder-Liquid mixer for anolyte adjustment | Stainless steel |
| p-001 | CO2 recirculation fan | Heavy gauge steel |
| p-002 | Catholyte centrigugal pump | Noryl |
| p-003 | Catholyte recirculation centrigugal pump | Noryl |
| p-004 | Condensed water pump | Noryl |
| p-005 | K2CO3/HCOOK slurry centrigugal pump | Noryl |
| p-006 | Anolyte centrigugal pump | Noryl |
| p-007 | O2 exhaust fan | Heavy gauge steel |
| p-008 | Anolyte recirculation centrifugal pump | Noryl |
| v-001 | CO2 regulator | Brass |
| v-002 | Catholyte solenoid valve N/O | Stainless steel |
| v-003 | 3-way directional valve | Nory1 |
| v-004 | Anolyte solenoid valve N/O | Stainless steel |

TABLE 6
identification of items found in FIG. 5.

| | | Mass | Temper- | |
|---|---|---|---|---|
| | | flow rate | ature | Pressure |
| Stream | Description | [kg/h] | [K] | [atm] |
| 1 | CO2 feed | 124.5 | 293 | 1-5 |
| 2 | CO2 recirculation | 108.1 | 293 | 1 |
| 3 | Catholyte 2M KOH for 1st | 326.7 | 293 | 1 |
| | loop in stack | | | |
| 4 | Catholyte recirculating in | 338.3-392.7 | 330-383* | 1 |
| | the stacks | | | |
| 5 | Catholyte after recirculating | 392.7 | 330-383* | 1 |
| | for 5 loops | | | |
| 6 | Water vapor from catholyte | 270.6 | 384 | 1 |
| 7 | Condensed water | 270.6 | 308 | 1 |
| 8 | K₂CO₃/HCOOK slurry | 24.4 | 293 | 1 |
| 9 | Alcohol vapor | 15.0 | 293 | 1 |
| 10 | HCOOK after evaporation | 12.0 | 293 | 1 |
| 11 | K₂CO₃ separated by | 6.7 | 293 | 1 |
| | centrifugation | | | |
| 12 | Anolyte 2M KOH | 326.7 | 293 | 1 |
| 13 | Anolyte and generated | 331.6 | 330-383* | 1 |
| | oxygen | | | |
| 14 | Degassed anolyte | 329.3 | 330-383* | 1 |
| 15 | Adjusted anolyte | 331.6 | 293 | 1 |

CO₂ is provided, e.g., at the plant location and can be temporarily compressed and stored prior its injection in two parallel stacks of electrochemical cells. In the cells, a small fraction of CO₂ is diffusing through the GDL to react with the catalyst and generate formate. Unreacted CO₂ is exiting both stacks and is recirculated with a fan blower in a semi-closed loop.

Catholyte, a 2M KOH solution, is stored in a polyethylene tank. It is injected in the stack and collects the generated formate product. In the present configuration, the catholyte needs to be recirculated in the stacks before the separation process in order to increase the formate concentration. The KOH electrolyte can either be recycled into for now due to its carbonation. KOH carbonation will increase the overall amount of CO₂ transformed by an electrolyser.

Before each of the recirculation loops, the catholyte is cooled down in a heat exchanger, since resistance effect causes heat of both catholyte and anolyte. The detail for the estimated 37-90 K increase of temperature is provided in Appendix 6. Once formate concentration reaches a target concentration, water found in the catholyte may be removed by injecting the catholyte in a waste heat boiler composed of a heat exchanger in contact with hot flue gas. The heat exchanger may be designed to evaporate, e.g., 90% of the water content (it will be understood that a higher amount of water may also be evaporated), leaving a slurry of K₂CO₃ and HCOOK. HCOOK separation is then achieved by the addition of alcohol and precipitating the insoluble K₂CO₃ while keeping HCOOK in solution. HCOOK is separated from alcohol through evaporation. The result formate salt can be stored.

Water steam from the waste heat boiler may be condensed and can be used to prepare new KOH solution that is used as catholyte. The anolyte may also be stored in, e.g., polyethylene tank and may be injected in the parallel stacks with the same mass flow rate than catholyte. On the anolyte side of the electrochemical cell, hydroxide ions react to form oxygen gas and water. The exiting anolyte is degassed first, and then cooled down to ambient temperature in a heat exchanger. In the present case, pure oxygen is vented, but could also be re-used in industry. The KOH concentration is finally adjusted before it can recirculate in the stack.

Certain components found in FIG. 5 are surrounded by a dash line and illustrate additional components that be added depending on the site location. These components may include: a CO₂ compressor, depending on what pressure, temperature and purity at which the CO₂ is fed to the electrolyser; a waste heat boiler, depending on the flue gas temperature that will be provided to the process. Calculations were done with low-grade heat at 200° C.; oxygen vent, which could be replaced by storage if the industries around the site location require pure streams of oxygen.

Exemplary Method of Converting Carbon Dioxide into Formate:

Reference is now made to FIG. 6, illustrating an exemplary method 600 of converting carbon dioxide into formate. It will be understood that the present method may be performed using a system as described in association with FIG. 2, or any other system in accordance with the present teachings.

Carbon dioxide is introduced into a stack of electrochemical cells at step 605. The carbon dioxide may originate from flue gas. The carbon dioxide may be compressed prior to introduction into the cell stack.

The carbon dioxide is introduced into a dry compartment of one or more electrochemical cells of the cell stack. The carbon dioxide then diffuses across a gas diffusion layer of the electrochemical cell into the cathodic compartment, and reacts with the catholyte to produce primarily potassium formate. In the anodic compartment, the anolyte produces oxygen. However, as explained herein, the catholyte will also contain potassium carbonate, resulting from a competing reaction occurring in the catholyte.

The concentration of formate in the catholyte is then measured (e.g. using a sensor) at step 610. In some examples, the concentration of other components or properties of the catholyte may instead be measured, providing information on the concentration of formate. If the concentration of formate does not meet a threshold concentration value, then the catholyte, with formate, is recirculated in the cell stack at step 615. This recirculation results in an increase in concentration of formate in the catholyte, as additional carbon dioxide may react with the ions (e.g. hydroxide ions) found in the catholyte, thereby producing more formate. This recirculation may be repeated any number of times until the threshold concentration of formate is met. In some examples, it will be understood that instead of providing a sensor for measuring the concentration of one or more components in the catholyte, indicative of a formate concentration, the system may instead be set to perform a fixed amount of recirculations of formate in the cell stack, where it can be predicted that such a number of recirculations will result in having the formate concentration approach a target concentration value.

Once the concentration of formate in the catholyte meets the threshold concentration value at step 610, water found in the catholyte is then removed (e.g. evaporated) at step 620. The evaporation process may remove a portion of the water in the catholyte, resulting in a slurry. Evaporation of water may be performed by adjusting one or more of the pressure and the temperature.

Optionally, the evaporated water originated from the catholyte may be recycled at step 625, or used to reduce energy consumption of one or more components of the electrolyser system (e.g. harnessing the heat of the water). The water may also be salvaged and used as a basis for new catholyte.

The catholyte with reduced water contains the potassium formate and potassium carbonate. Separation of potassium formate from potassium carbonate is then performed to result in the potassium formate. A solvent is added to the mixture containing potassium carbonate and potassium formate at step 630. The solvent is selected to allow the potassium formate or the potassium carbonate to dissolve therein. In some examples, the solvent may result in the separation, through dissolution, of one of the two (potassium formate or potassium carbonate) at certain set parameters (e.g. fixed pressure, temperature). An exemplary solvent is ethanol, resolving in the dissolution of potassium formate, but not potassium carbonate.

The solvent with dissolved potassium carbonate or potassium formate is then removed, resulting in the separation of potassium formate from potassium carbonate at step 635, where potassium formate is retained.

When potassium formate is dissolved in the solvent, removal of the solvent is then performed, resulting in the precipitation of the potassium formate. For instance, when the solvent is ethanol, the ethanol may be heated, resulting in its evaporation.

The extracted potassium formate may then be stored, e.g., for future use at step 640. The potassium formate may be stored as a solid, or dissolved in a solvent to form a solution.

The anolyte, following the electrochemical reaction, may be removed from the electrochemical cell and degassed to remove the oxygen. The anolyte may also be passed through a heat exchanger to lower its temperature prior to the recirculation of the anolyte in the electrochemical cell stack. The concentration of the anolyte may also be verified and/or adjusted prior to reintroduction in the cell stack.

Although the invention has been described with reference to preferred embodiments, it is to be understood that modifications may be resorted to as will be apparent to those skilled in the art. Such modifications and variations are to be considered within the purview and scope of the present invention.

Representative, non-limiting examples of the present invention were described above in detail with reference to the attached drawing. This detailed description is merely intended to teach a person of skill in the art further details for practicing preferred aspects of the present teachings and is not intended to limit the scope of the invention. Furthermore, each of the additional features and teachings disclosed above and below may be utilized separately or in conjunction with other features and teachings.

Moreover, combinations of features and steps disclosed in the above detailed description, as well as in the experimental examples, may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

### REFERENCES

[1] IPCC, IPCC CLIMATE CHANGE 2013 Climate Change 2013. 2013.
[2] United States Environmental Protection Agency, “Inventory of U.S. greenhouse gas emissions and sinks: 1990-2009,” vol. 76, no. 36, p. 10026, 2011.
[3] S. Rathee and A. Kumar, “Transportation effects on Environment and Health Issues,” Int. J. Enhanc. Res. Sci. Technol. Eng., vol. 6, no. 9, pp. 101-106, 2017.
[4] M. Bui et al., “Carbon capture and storage (CCS): The way forward,” Energy Environ. Sci., vol. 11, no. 5, pp. 1062-1176, 2018, doi: 10.1039/c7ee02342a.
[5] S. Douieb, S. Archambault, L. Fradette, F. Bertrand, and B. Haut, “Effect of the fluid shear rate on the induction time of CO₂-THF hydrate formation,” Can. J. Chem. Eng., vol. 95, no. 1, pp. 187-198, 2017, doi: 10.1002/cjce.22650.
[6] J. Albo, M. Alvarez-Guerra, P. Castaño, and A. Irabien, “Towards the electrochemical conversion of carbon dioxide into methanol,” Green Chem., vol. 17, no. 4, pp. 2304-2324, 2015, doi: 10.1039/c4gc02453b.
[7] J. Artz et al., “Sustainable Conversion of Carbon Dioxide: An Integrated Review of Catalysis and Life Cycle Assessment,” Chem. Rev., vol. 118, no. 2, pp. 434-504, 2018, doi: 10.1021/acs.chemrev.7b00435.
[8] U. Legrand, R. Boudreault, and J. L. Meunier, “Decoration of N-functionalized graphene nanoflakes with copper-based nanoparticles for high selectivity CO₂ electroreduction towards formate,” Electrochim. Acta, vol. 318, pp. 142-150, 2019, doi: 10.1016/j.electacta.2019.06.074.
[9] W. Su, H. Rahimi-eichi, W. Zeng, and M. Chow, “Smart Grid Environment,” Control, vol. 8, no. 1, pp. 1-10, 2012.
[10] H. Li et al., “Ultrasound assisted wet media milling synthesis of nanofiber-cage LiFePO4/C,” Ultrason. Sonochem., vol. 68, 2020, doi: 10.1016/j.ultsonch.2020.105177.
[11] M. G. Rigamonti et al., “LiFePO4 spray drying scale-up and carbon-cage for improved cyclability,” J. Power Sources, vol. 462, no. March, 2020, doi: 10.1016/j.jpowsour.2020.228103.
[12] M. S. Whittingham, “History, Evolution, and Future Status of Energy Storage,” Proc. IEEE, vol. 100, pp. 1518-1534, 2012.
[13] D. Reay, “The role of process intensification in cutting greenhouse gas emissions,” Appl. Therm. Eng., vol. 28, no. 16, pp. 2011-2019, 2008, doi: 10.1016/j.applthermaleng.2008.01.004.
[14] D. Fernandez Rivas et al., “Process intensification education contributes to sustainable development goals. Part 1,” Educ. Chem. Eng., vol. 32, pp. 1-14, 2020, doi: 10.1016/j.ece.2020.04.003.
[15] Z. P. Cano et al., “Batteries and fuel cells for emerging electric vehicle markets,” Nat. Energy, vol. 3, no. 4, pp. 279-289, 2018, doi: 10.1038/s41560-018-0108-1.
[16] M. Kane, “Global EV Sales For 2019 Now In: Tesla Model 3 Totally Dominated,” 2020. https://insideevs.com/news/396177/global-ev-sales-december-2019/.
[17] B. Nykvist and M. Nilsson, “Rapidly falling costs of battery packs for electric vehicles,” Nat. Chim. Chang., vol. 5, no. 4, pp. 329-332, 2015, doi: 10.1038/nclimate2564.
[18] S. Edelstein, “BMW re-ups electric-vehicle commitment and hydrogen fuel-cell investment,” 2020, [Online]. Available: https://www.greencarreports.com/news/1128075_bmw-re-ups-electric-vehicle-commitment-and-hydrogen-fuel-cell-investment.
[19] D. Blekhman, “Volvo's Fuel Cell Truck Alliance With Daimler Is A Return To The Hydrogen Bandwagon,” 2020. https://www.forbes.com/sites/davidblekhman/2020/05/08/volvos-fuel-cell-truck-alliance-with-daimler-is-a-return-to-the-hydrogen-bandwagon/#770306f827ff.
[20] A. Caglar, B. Ulas, M. S. Cogenli, A. B. Yurtcan, and H. Kivrak, “Synthesis and characterization of Co, Zn, Mn, V modified Pd formic acid fuel cell anode catalysts,” J. Electroanal. Chem., vol. 850, 2019, doi: 10.1016/j.jelechem.2019.113402.
[21] A. C. Fernandez-Pello, “Micropower generation using combustion: Issues and approaches,” Proc. Combust. Inst., vol. 29, no. 1, pp. 883-899, 2002, doi: 10.1016/s1540-7489(02)80113-4.
[22] S. Ha, Z. Dunbar, and R. I. Masel, “Characterization of a high performing passive direct formic acid fuel cell,” J. Power Sources, vol. 158, no. 1, pp. 129-136, 2006, doi: 10.1016/j.jpowsour.2005.09.048.
[23] Y. Hori, H. H. I. Wakebe, T. Tsukamoto, and O. Koga, “Electrocatalytic Process Of Co Selectivity In Electrochemical Reduction Of Co2 At Metal Electrodes In Aqueous Media,” vol. 39, 1994.
[24] J. Rosen et al., “Mechanistic Insights into the Electrochemical Reduction of CO₂ to CO on Nanostructured Ag Surfaces,” ACS Catal., vol. 5, no. 7, pp. 4293-4299, 2015, doi: 10.1021/acscatal.5b00840.
[25] G. B. Stevens, T. Reda, and B. Raguse, “Energy storage by the electrochemical reduction of CO₂ to CO at a porous Au film,” J. Electroanal. Chem., vol. 526, no. 1-2, pp. 125-133, 2002, doi: 10.1016/S0022-0728(02)00688-5.
[26] J. W. Raebiger et al., “Electrochemical reduction of CO 2 to CO catalyzed by a bimetallic palladium complex,” Organometallics, vol. 25, no. 14, pp. 3345-3351, 2006, doi: 10.1021/om060228g.
[27] L. Han, W. Zhou, and C. Xiang, “High-Rate Electrochemical Reduction of Carbon Monoxide to Ethylene Using Cu-Nanoparticle-Based Gas Diffusion Electrodes,” ACS Energy Lett., vol. 3, no. 4, pp. 855-860, 2018, doi: 10.1021/acsenergylett.8b00164.
[28] C. Cui et al., “Promotional effect of surface hydroxyls on electrochemical reduction of CO₂ over SnOx/Sn electrode,” J. Catal., vol. 343, pp. 257-265, 2016, doi: 10.1016/j.jcat.2015.12.001.
[29] Q. G. Zhu, X. F. Sun, X. C. Kang, J. MA, Q. L. Qian, and B. X. Han, “Cu2S on cu foam as highly efficient Electrocatalyst for Reduction of Co2 to formic acid,” Wuli Huaxue Xuebao/ActaPhys.-Chim. Sin., vol. 32, no. 1, pp. 261-266, 2016, doi: 10.3866/PKU.WHXB201512101.
[30] P. Louyot, C. Neagoe, F. Galli, C. Pirola, G. S. Patience, and D. C. Boffito, “Ultrasound-assisted impregnation for high temperature Fischer-Tropsch catalysts,” Ultrason. Sonochem., vol. 48, pp. 523-531, 2018, doi: 10.1016/j.ultsonch.2018.06.017.
[31] Z. Ma et al., “A micro-refinery to reduce associated natural gas flaring,” Sustain. Cities Soc., vol. 27, pp. 116-121, 2016, doi: 10.1016/j.scs.2016.06.012.
[32] R. Andika et al., “Co-electrolysis for power-to-methanol applications,” Renew. Sustain. Energy Rev., vol. 95, no. July, pp. 227-241, 2018, doi: 10.1016/j.rser.2018.07.030.
[33] R. Franke, D. Selent, and A. Borner, “Applied hydroformylation,” Chem. Rev., vol. 112, no. 11, pp. 5675-5732, 2012, doi: 10.1021/cr3001803.
[34] N. M. Markovi and P. N. Ross, “Surface science studies of model fuel cell electrocatalysts,” Surf Sci. Rep., vol. 45, no. 4-6, pp. 117-229, 2002, doi: 10.1016/s0167-5729(01)00022-x.
[35] K. N. Ahmad, A. M. I. Noor Azam, W. N. R. W. Isahak, A. Mohd Zainoodin, and M. S. Masdar, “Improving the electrocatalytic activity for formic acid oxidation of bimetallic Ir—Zn nanoparticles decorated on graphene nanoplatelets,” Mater. Res. Express, vol. 7, no. 1, 2020, doi: 10.1088/2053-1591/ab6c95.
[36] M. Yang, X. Zhu, Y. Tang, P. Wu, and T. Lu, “Highly dispersed ultrafine palladium nanoparticles on three-dimensional mesoporous carbon for formic acid electro-oxidation,” Ionics (Kiel)., vol. 21, no. 9, pp. 2609-2614, 2015, doi: 10.1007/s11581-015-1445-8.
[37] X. Yu and P. G. Pickup, “Recent advances in direct formic acid fuel cells (DFAFC),” J. Power Sources, vol. 182, no. 1, pp. 124-132, 2008, doi: 10.1016/j.jpowsour.2008.03.075.
[38] S. Moret, P. J. Dyson, and G. Laurenczy, “Direct synthesis of formic acid from carbon dioxide by hydrogenation in acidic media,” Nat. Commun., vol. 5, pp. 1-7, 2014, doi: 10.1038/ncomms5017.
[39] OEC, “Formic Acid.” https://oec.world/en/profile/hs92/6291511/.
[40] IHSMarkitChem, Formic Acid, in: Chemical Economics Handbook (ECH). 2016.
[41] Technavio Research, “Research Report with COVID-19 Forecasts-Global Formic Acid Market 2020-2024| Rising Demand for Formic Acid as a Preservative to Boost Market Growth|Technavio,” 2020. https://finance.yahoo.com/news/research-report-covid-19-forecasts-190000327.html.
[42] Business Wire, “Global Formic Acid Market Analysis 2020 with Forecasts to 2027: Impact of Covid-19 and a Looming Global Recession—ResearchAndMarkets.com,” 2020. https://apnews.com/press-release/business-wire/8bb7d2c187564671834e9efe17a2d4e2.
[43] Research and Markets, “Formic Acid—Global Market Trajectory & Analytics,” 2020. https://www.researchandmarkets.com/reports/354885/formic_acid_global_market_trajectory_an d?utm_source=dynamic&utm_medium=BW&utm_code=bmsrdk&utm_campaign=1401072+-+Global+Formic+Acid+Market+Analysis+2020+with+Forecasts+to+2027%3A+Impact+of+Cov id-19+ and+a+L.
[44] J. Hietala, A. Vuori, P. Johnsson, I. Pollari, W. Reutemann, and H. Kiesczka, “Formic acid,” ICIS Chem. Bus., vol. 1, no. 29, pp. 1-12, 2017.
[45] D. A. Bulushev and J. R. H. Ross, “Towards Sustainable Production of Formic Acid,” ChemSusChem, vol. 11, no. 5, pp. 821-836, 2018, doi: 10.1002/cssc.201702075.
[46] M. Rumayor, A. Dominguez-Ramos, and A. Irabien, “Formic Acid manufacture: Carbon dioxide utilization alternatives,” Appl. Sci., vol. 8, no. 6, pp. 1-12, 2018, doi: 10.3390/app8060914.
[47] K. Tanaka and D. Ooyama, “Multi-electron reduction of CO₂ via Ru—CO₂, —C(O)OH, —CO, —CHO, and —CH2OH species,” in Coordination Chemistry Reviews, March 2002, vol. 226, no. 1-2, pp. 211-218, doi: 10.1016/S0010-8545(01)00434-9.
[48] N. Furuya, T. Yamazaki, and M. Shibata, “High performance Ru—Pd catalysts for CO₂ reduction at gas-diffusion electrodes,” J. Electroanal. Chem., vol. 431, no. 1, pp. 39-41, June 1997, doi: 10.1016/S0022-0728(97)00159-9.
[49] X. Zheng et al., “Sulfur-Modulated Tin Sites Enable Highly Selective Electrochemical Reduction of CO₂ to Formate,” Joule, vol. 1, no. 4, pp. 794-805, December 2017, doi: 10.1016/j.joule.2017.09.014.
[50] D. M. Weekes, D. A. Salvatore, A. Reyes, A. Huang, and C. P. Berlinguette, “Electrolytic CO₂ Reduction in a Flow Cell,” Acc. Chem. Res., vol. 51, no. 4, pp. 910-918, 2018, doi: 10.1021/acs.accounts.8b00010.
[51] C. T. Dinh et al., “CO₂ electroreduction to ethylene via hydroxide-mediated copper catalysis at an abrupt interface,” Science (80-.)., vol. 360, no. 6390, pp. 783-787, 2018, doi: 10.1126/science.aas9100.
[52] K. Liu, W. A. Smith, and T. Burdyny, “Introductory Guide to Assembling and Operating Gas Diffusion Electrodes for Electrochemical CO 2 Reduction,” ACS Energy Lett., vol. 4, no. 3, pp. 639-643, 2019, doi: 10.1021/acsenergylett.9b00137.
[53] M. Jitaru and M. Jitaru, “Electrochemical carbon dioxide reduction—Fundamental and applied topics ELECTROCHEMICAL CARBON DIOXIDE (REVIEW),” no. November, 2015.
[54] U. Legrand, U.-P. Apfel, D. C. Boffito, and J. R. Tavares, “The effect of flue gas contaminants on the CO<inf>2</inf>electroreduction to formic acid,” J. CO2 Util., vol. 42, 2020, doi: 10.1016/j.jcou.2020.101315.
[55] U. Legrand, J. K. Lee, A. Bazylak, and J. R. Tavares, “Product Crossflow through a Porous Gas Diffusion Layer in a CO₂Electrochemical Cell with Pressure Drop Calculations,” Ind. Eng. Chem. Res., vol. 60, no. 19, pp. 7187-7196, 2021, doi: 10.1021/acs.iecr.1c01316.
[56] N. Gupta, M. Gattrell, and B. MacDougall, “Calculation for the cathode surface concentrations in the electrochemical reduction of CO₂ in KHCO3 solutions,” J. Appl. Electrochem., vol. 36, no. 2, pp. 161-172, 2006, doi: 10.1007/s10800-005-9058-y.
[57] T. L. Bergman, F. P. Incropera, D. P. DeWitt, and A. S. Lavine, Fundamentals of heat and mass transfer, 7th Editio. 2011.
[58] Battelle, “MANUFACTURING COST ANALYSIS OF 10 KW AND 25 KW DIRECT HYDROGEN POLYMER ELECTROLYTE MEMBRANE (PEM) FUEL CELL FOR MATERIAL HANDLING,” 2013.

1. A method of producing formate salt from carbon dioxide using at least one electrochemical cell with a dry compartment for receiving carbon dioxide gas, a first wet compartment with a catholyte solution, where a gas diffusion layer separates the dry compartment and the first wet compartment, and a second wet compartment with an anolyte solution, comprising:
receiving the carbon dioxide in the dry compartment, wherein the carbon dioxide diffuses from the dry compartment into the catholyte solution of the first wet compartment through the gas diffusion layer, and at least part of the carbon dioxide is transformed into formate by an electrochemical reaction, resulting in a formate-containing catholyte solution, whereby a carbonate by-product is also produced from the carbon dioxide, remaining in the formate-containing catholyte solution;
concentrating the formate in the formate-containing catholyte solution;
separating the concentrated formate and the carbonate from the water of the formate-containing catholyte solution; and
separating the carbonate from the formate to result in isolated formate salt.

2. The method as defined in claim 1, further comprising storing the isolated formate salt.

3. The method as defined in claim 1, wherein the carbon dioxide is pressurized prior to the receiving.

4. The method as defined in claim 1, wherein the at least one electrochemical cell includes a plurality of electrochemical cells forming a cell stack.

5. The method as defined in claim 1, wherein the concentrating is performed by reintroducing the formate-containing catholyte solution into the at least one electrochemical cell, thereby permitting additional carbon dioxide to react with the catholyte through an electrochemical reaction of the formate-containing catholyte solution to generate additional formate, increasing the concentration of the formate in the formate-containing catholyte solution.

6. The method as defined in claim 1, further comprising, after the concentrating, detecting a concentration of one or more solutes in the formate-containing catholyte solution, indicative of a concentration of formate in the formate-containing catholyte solution.

7. The method as defined in claim 6, wherein a concentration of formate is detected in the formate-containing catholyte solution.

8. The method as defined in claim 1, where the catholyte solution and the anolyte solution contain hydroxide salt.

9. The method as defined in claim 8, wherein the anolyte solution leaving the at least one electrochemical cell is degassed to remove oxygen resulting from an electrochemical reaction of the anolyte solution occurring in the second wet compartment, and passed through a heat exchanger to remove heat prior to reintroduction into the at least one electrochemical cell.

10. The method as defined in claim 9, wherein a concentration of the anolyte solution is verified and adjusted prior to the reintroduction.

11. The method as defined in claim 1, wherein the separating the concentrated formate and the carbonate from the water is performed using heat.

12. The method as defined in claim 1, wherein the separating the carbonate from the formate to result in formate salts is performed by adding a solvent that dissolves the formate but not the carbonate, and wherein the solvent is then evaporated to result in the formate salts.

13. The method as defined in claim 12, wherein the solvent is ethanol.

14. The method as defined in claim 1, wherein the isolated formate salt is crystallized.

15. The method as defined in claim 1, wherein unreacted carbon dioxide of the carbon dioxide is recirculated in the at least one electrochemical cell.

16. Formate salt obtained by performing the method as defined in claim 1.

17. The formate salt as defined in claim 16, wherein the formate salt is in crystal form.

18. The formate salt as defined in claim 16, wherein the formate salt is a liquid solution.

19. A system for transforming carbon dioxide into formate, comprising:
a catholyte storage subsystem comprising a catholyte storage vessel with a catholyte solution;
an anolyte storage subsystem comprising an anolyte storage vessel with an anolyte solution;
a carbon dioxide inlet connected to the electrolyser for supplying carbon dioxide to an electrolyser;
the electrolyser comprising at least one electrochemical cell with a dry compartment for receiving carbon dioxide gas, a first wet compartment with the catholyte solution supplied from the catholyte storage subsystem, where a gas diffusion layer separates the dry compartment and the first wet compartment, and a second wet compartment with the anolyte solution supplied from the anolyte storage subsystem, and configured to receive the carbon dioxide in the dry compartment, wherein the carbon dioxide diffuses from the dry compartment into the catholyte solution of the first wet compartment through the gas diffusion layer, and at least part of the carbon dioxide is transformed into formate by an electrochemical reaction, resulting in a formate-containing catholyte solution, whereby a carbonate by-product is also produced from the carbon dioxide, remaining in the formate-containing catholyte solution;
a controller configured to determine if a threshold concentration of the formate in the formate-containing catholyte solution is reached, wherein the formate-containing catholyte is recirculated in the at least one electrochemical cells if the threshold concentration is not reached;
a formate separation subsystem configured to:
remove at least part of the water from the formate-containing catholyte solution; and
separate the formate from the carbonate.

20. The system as defined in claim 19, further comprising an anolyte pH adjustment subsystem configured to:
receive used anolyte solution leaving the electrolyser; and
adjust a concentration of a recycled anolyte solution at least including the used anolyte solution to a target concentration.
